(19) United States
(12) Patent Application Publication
(10) Pub. No.: US 2008/0295547 A1
(43) Pub. Date: Dec. 4, 2008

(54) DEVICE FOR GENERATING STEAM IN A LAUNDRY APPLIANCE, AND LAUNDRY APPLIANCE

(75) Inventors: Michael Finke, Hoevelhof (DE); Friedrich-Wilhelm Kramme, Ruethen (DE); Robert Muether, Rheda-Wiedenbrueck (DE); Wilfried Schaeffersmann, Bielefeld (DE); Dirk Sieding, Luenen (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 12/129,204

(22) Filed: May 29, 2008

(30) Foreign Application Priority Data
May 29, 2007 (DE) 10 2007 025 046.2

(51) Int. Cl. B08B 3/00; F24H 1/18; D06F 37/00; F26B 11/02

(52) U.S. Cl. 68/5 C; 392/458; 68/5 R; 34/596

(57) ABSTRACT

A steam-generating-device configured to generate steam that is passed through a conduit and a nozzle into a container of a laundry appliance that is configured to receive laundry. The steam-generating device includes a tank with an interior space and a heating element. Water is admitted into the tank through an inlet opening, and an outlet opening is provided for water and/or steam. A bulkhead extends up from a bottom of the tank between the outlet opening and the interior space. The bulkhead has an upper edge forming at least one opening so as to provide a passage for the steam between the interior space and the outlet opening. The upper edge protrudes above a storage water level of the tank.

### CROSS REFERENCE TO RELATED APPLICATIONS

Priority is claimed to German patent application DE 10 2007 025 046.2, filed May 29, 2007, which is hereby incorporated by reference herein.

### FIELD

The present invention relates to a device for generating steam that can be passed through a conduit and a nozzle into a container of a laundry appliance and a laundry appliance having the device.

### BACKGROUND

European Patent Document EP 1 544 345 A2 describes a device for generating steam in a washing machine. The washing machine has a suds container for receiving wash liquid and the laundry to be treated. The device for generating steam, also referred to as steam generator, has a tank for receiving the liquid to be evaporated and a heating element for heating said liquid. The washing machine further includes a means for spraying or introducing water into the suds container, said means having a nozzle in the edge region of the door opening. This washing machine is provided with a separate nozzle for admission of water, and a further nozzle or tube end for the steam, the supply lines passing through the bellows seal. Access to the interior of the suds container is somewhat impaired by the two separate nozzles disposed in the region of the door opening. There is also a risk that laundry items which are carried along during operation may get caught on one of the nozzles, so that the nozzle or the laundry items may be damaged. The container is provided with separate openings for water intake, for water discharge, and for steam discharge, respectively.

European Patent Document EP 1 464 750 A1 describes a washing machine having a suds container for receiving wash liquid and the laundry to be treated. The washing machine includes a steam generator used for steaming of the laundry. The liquid to be evaporated is held in a tank and heated by a heating element therein. The steam is passed through a conduit and a nozzle into the treatment chamber, i.e., into the interior of the drum. Moreover, water can be passed into the interior of the drum through the same conduit and nozzle. The inlet is directly connected to the water supply and is controlled by a valve. The steam generator device includes a tank which is provided with a heating element and into which water is introduced through the valve. The steam is discharged through a tube which extends into the tank from below and terminates therein. The tank has partitions extending therein from the top and bottom sides thereof, said partitions surrounding the aforementioned tube and preventing incoming water from flowing out of the tank through the tube end. This arrangement is intended to allow water to be continuously introduced into the tank through the inlet valve during the generation of steam. Since the heating element is located in the region of the outlet opening or tube, bubbles may form during the generation of steam, and drops or, occasionally, a gush of water may enter the opening of the tube for the exiting steam. However, this is not desired to occur during laundry treatment, because the laundry to be steamed would get partially too wet again.

### SUMMARY

In an embodiment, an aspect of the present invention is to provide an improved steam generator device for use in a laundry appliance which can prevent water from exiting during the generation of steam.

In an embodiment, the invention provides steam-generating-device configured to generate steam that is passed through a conduit and a nozzle into a container of a laundry appliance that is configured to receive laundry. The steam-generating device includes a tank with an interior space and a heating element. Water is admitted into the tank through an inlet opening, and an outlet opening is provided for water and/or steam. A bulkhead extends up from a bottom of the tank between the outlet opening and the interior space. The bulkhead has an upper edge forming at least one opening so as to provide a passage for the steam between the interior space and the outlet opening. The upper edge protrudes above a storage water level of the tank.

### BRIEF DESCRIPTION OF THE DRAWINGS

Exemplary embodiments of the present invention will be described in more detail below and are shown in the drawings in which: and

FIG. 1 is a schematic cross-sectional view of a laundry appliance having a device for generating steam;

FIG. 2 is a perspective view of a device for generating steam in accordance with the invention;

FIGS. 3a, 3b are detailed cross-sectional views of a steam generator device having a movable bulkhead;

FIG. 4 is a perspective view of a device for generating steam in accordance with the invention; and

FIG. 5 is a detailed cross-sectional view of a steam generator device having a siphon.

### DETAILED DESCRIPTION

In an embodiment the invention provides a device for generating steam that can be passed through a conduit and a nozzle into a container of a laundry appliance. The container is used for receiving laundry to be treated. The steam-generating device includes a tank, a heating element, an inlet opening for admitting water into the tank, and an outlet opening for steam or water. In another embodiment, the present invention relates to a laundry appliance having a device for generating steam that can be passed through a conduit and a nozzle into a container of a laundry appliance, the container being used for receiving laundry to be treated.

In accordance with an embodiment of the present invention, at least one bulkhead extends substantially vertically upward from the bottom of the tank between the outlet opening and the interior space thereof, the upper edge of the bulkhead having or forming at least one opening to provide a passage between the interior space of the tank and the outlet opening. The height of the bulkhead is sized such that, when the steam generator device is in its normal position, the upper edge of the bulkhead protrudes above the water level that can be stored in the tank. The steam generator device of the present invention has the important advantage that no water will gush through the outlet opening to the nozzle and therethrough onto the laundry in the drum during the generation of steam. Bubbling water, which is produced during steam generation by boiling, is retained by the bulkhead, i.e., by the protruding portion of the bulkhead, so that at least substantially no drops or splashes can enter the outlet opening located therebehind. At the upper edge of the bulkhead, there is provided an opening which permits steam to pass therethrough during steam generation.

In an embodiment, the bulkhead is movably mounted to allow adjustment of the water level to be stored. In a first position, the bulkhead rests on the bottom of the tank while the upper edge protrudes above the water level. In a second position, it is spaced from the bottom, or at least provides a passage between the interior space of the tank and the outlet opening. In this condition, the water introduced into the tank through the inlet opening flows out of the outlet opening to the nozzle until the level reaches the edge of the retention dam permanently formed at the bottom of the tank. This defines the water level to be stored in the tank. Prior to heating and evaporating the water by the heating element, the bulkhead can be moved to the first position so as to prevent the water from gushing over the dam edge into outlet opening.

In an embodiment, the device for generating steam includes an electrically controllable actuator which is capable of moving the bulkhead, i.e., of driving the movement of the bulkhead. Actuators that may be used include a spindle drive servomotor or an electromagnetically operated linear cylinder-type actuator operatively connected to the bulkhead by levers or cables.

In one suitable embodiment, the bulkhead is pivotally mounted, which allows for reliable and easy movement thereof.

In another embodiment, at least one baffle plate is disposed within the tank, said baffle plate extending from the top of the tank and being spaced from the bulkhead by a distance between about one-third and one-half of the longitudinal extent of the tank between the bulkhead and the opposite end of the tank. This prevents the formation of larger waves or splashes of water in the tank, which could get past the bulkhead and to the outlet opening. The baffle plates act here as wave breakers.

In an embodiment, the baffle plate is dimensioned such that its lower edge terminates at or above the surface of the water in the tank. Thus, the flow of water is not impaired when no steam is generated, which allows for reliable introduction of water.

In a different embodiment, a duct is disposed between the interior space of the tank and the outlet opening, the duct acting as a siphon and providing the opening and passage to the outlet opening for the steam. The duct opening that projects into the tank is disposed at a lower level than the upper apex of the duct, which forms the upper edge of the bulkhead, or extends over said upper edge. The duct opening projecting in the duct defines the water level to be stored in the tank.

In an embodiment, the siphon is inclined on the side facing the tank, the angle being about 30 to 60 degrees with respect to the horizontal. This allows for improved flow of water over the bulkhead, i.e., through the siphon duct, during the introduction of water.

Furthermore, the inlet opening can be disposed within the tank at the side remote from the bulkhead and outlet opening. This ensures that the flow traverses the entire length of the tank as water is introduced. Thus, any deposits or other residues are flushed out, ensuring that the water supply in the tank is always completely renewed. This is particularly helpful when no steam is generated during a prolonged period of time and the tank is not completely emptied during this time. This could cause growth of germs or unpleasant odors from the tank or from the nozzle.

In an embodiment, the heating element is mounted externally to the underside of the tank. Thus, the region to be heated can be configured very flat, thereby preventing deposits on the heating element. Moreover, the stored volume of water can be completely evaporated, which is not guaranteed when using an internal tubular heating element.

In another suitable embodiment, a mounting device for mounting the steam generation device is integrally formed with the tank on the outside thereof, thus facilitating mounting within the housing of the laundry appliance.

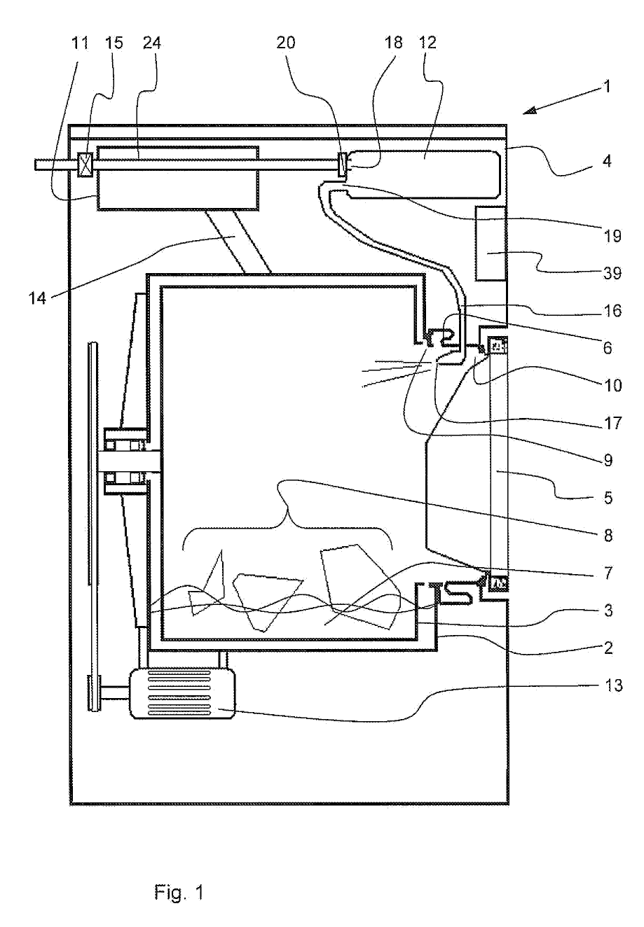

FIG. 1 illustrates, in a purely schematic way, a laundry appliance 1, here a washing machine, having a suds container 2. Positions and directions are given relative to the laundry appliance in its upright position of use. A drum 3 driven by an electric motor 13 is rotatably mounted within suds container 2, said drum moving the laundry 8 present in suds container 2. In this embodiment, drum 3 is made of stainless steel and provided with a plurality of openings permitting flow therethrough. The lower region of suds container 2 holds the wash liquid 7 or water required for the cleaning or treatment of laundry 8. The warming or heating of liquid 7 is accomplished by a heating element disposed in the lower region of suds container 2. An inlet valve 15 is indicated in the upper portion of appliance 1, the inlet valve controlling the introduction of water from the water supply system. Water is introduced into suds container 2 through dispensing compartment 11 and connecting tube 14. In the process, detergent which has been filled into dispensing compartment 11 is washed into suds container 2. In addition, laundry appliance 1 has a device 12 for generating steam that can be injected into the interior of suds container 2, i.e., into the interior of drum 3, via a conduit 16 and a nozzle 17 connected thereto. Nozzle 17 is mounted in the upper region of a bellows seal 6 which provides the connection between opening 9 in suds container 2 and opening 10 in housing 4, which can be closed by door 5.

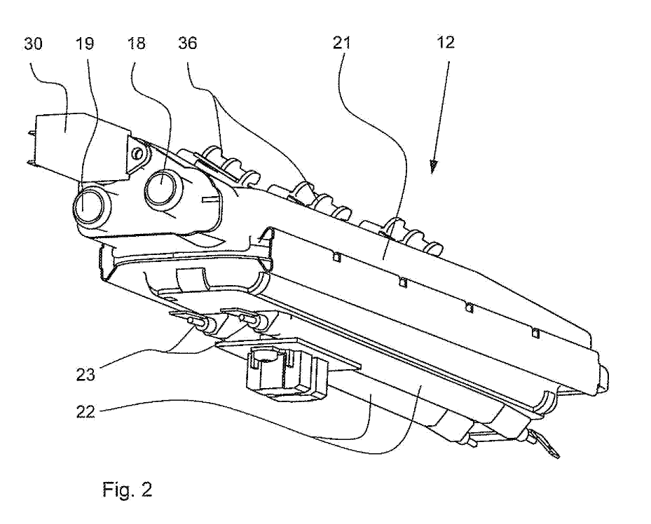

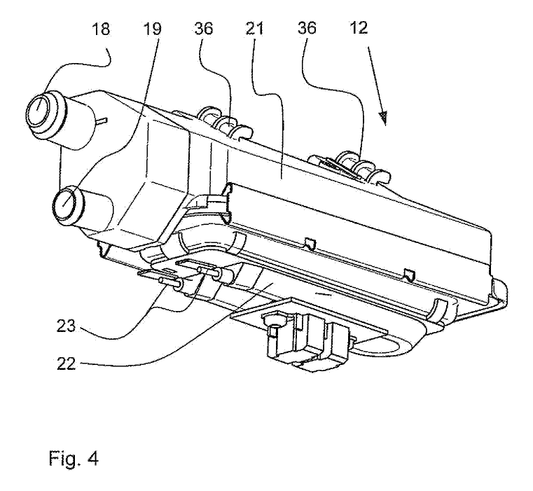

Referring to FIG. 1, steam generator device 12 is provided with a check valve 20 at water inlet opening 18, the check valve preventing steam generated in tank 21 from escaping through this opening 18. Connected to outlet opening 19 is a conduit through which the steam or water to be introduced is passed to nozzle 17. Nozzle 17 is mounted at the edge of opening 9 in the treatment chamber in the upper portion thereof, here in the region of bellows seal 6, and is directed toward the interior of suds container 2 so as to effectively spray steam onto laundry 8 present in suds container 2, i.e., in drum 3. A controller 39 controls the operations to be performed during a laundry or wash cycle and during the generation of steam, such operations including, in particular, the control of inlet valve 15 and of a heating element 26 (FIGS. 2, 4).

Instead of a washing machine, the laundry appliance 1 may also be a dryer which contains a rotatable drum, but in which there is no suds container and no bellows seal between the suds container and the housing opening. Here, nozzle 17 is disposed in the edge region of the housing opening, so as to allow the steam to be injected into the interior of the drum.

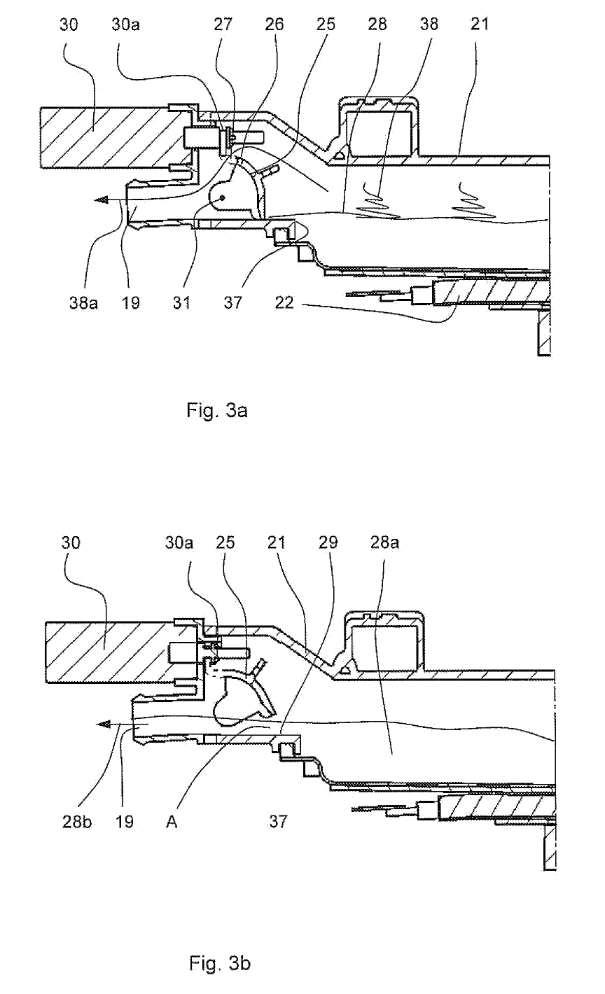

In FIG. 2, steam generator device 12 is shown separately. Steam generator device 12 includes a tank 21, a heating element 22, an inlet opening 18, and a common outlet opening 19 for steam and water. Electrical power for heating the water present in tank 21 is supplied to heating element 22 via terminals 23. The steam generator device 12 shown here is intended for the embodiment that includes a movable bulkhead 25 (FIGS. 3a, 3b). The movement of bulkhead 25 is accomplished by an externally mounted, electrically controllable actuator 30. In the embodiments shown in FIGS. 2 and 4, tank 21 has attached thereto, or integrally formed therewith, a mounting device 36 for mounting steam generator device 12 within housing 4 of laundry appliance 1 (FIG. 1).

FIG. 3a is a cross-sectional view of the outlet region of steam generator device 12, showing bulkhead 25 in a first, closed position. Here, water level 28 in tank 21 is approximately at the level of dam edge 37. The heat released by heating element 22 causes water 28a to boil and evaporate. The rising steam 38 produces an overpressure of about 5 to 30 mm of water head in tank 21, as a result of which the steam passes through opening 27 in the region of upper edge 26 of bulkhead 25 and exits from tank 21 through outlet opening 19, as indicated by arrow 38a. The actuator 30 used here is an electromagnetic linear cylinder-type actuator, which transfers the motion to the bulkhead via levers 30a. Here, the lower end of bulkhead 25, which is supported by pivot pin 31, is pressed by the extended linear actuator onto the bottom of tank 21. Bulkhead 25 keeps bubbling water and splashes away from outlet opening 19, so that only the purest steam 38 is passed from tank 21 of steam generator device 12 to the laundry.

FIG. 3b is a cross-sectional view of the outlet region of steam generator device 12, showing bulkhead 25 in a second, open position. In this second position, the bulkhead is spaced from the bottom, providing at least a passage A between the interior space of the tank and the outlet opening. In this position, the water 28a introduced into tank 21 flows through passage A and exits tank 21 through outlet opening 19, as indicated by arrow 28b. In this process, only the volume of water above dam edge 37 will flow out. Once water level 28 falls to the level of dam edge 37, the flow of water stops. In this process, the cylinder of actuator 30 is retracted, so that bulkhead 25, which is supported by pivot pin 31, is lifted from the bottom of tank 21 by means of lever 30a. This is the position in which water is introduced into suds container 2 (FIG. 1).

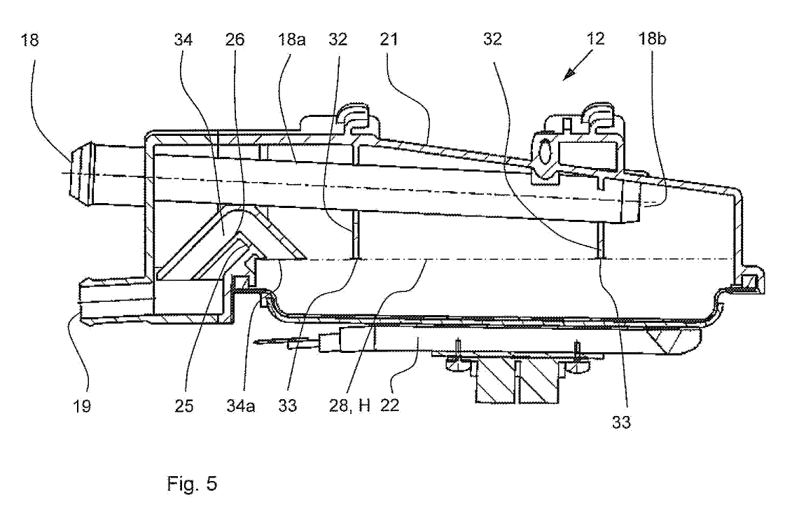

FIG. 4 shows an embodiment of steam generator device 12 that includes a siphon 34 (FIG. 5). This steam generator device includes a tank 21, a heating element 26, an inlet opening 18, and a common outlet opening 19 for steam and water. Electrical power for heating the water present in tank 21 is supplied to heating element 22 via terminals 23.

The cross-sectional schematic view of FIG. 5 shows the configuration of the siphon, which is in the form of a duct 34 and extends over upper edge 26 of bulkhead 25. When water is admitted through inlet opening 18 and passed through tube 18a to tank-side port 18b, and therethrough into tank 21, the water level in tank 21 rises. Once the water level rises above upper edge 26 of bulkhead 25, the excess water flows out through outlet opening 19. Due to the siphon effect of duct 34, water flows out until the water level is below duct opening 34a. The position of duct opening 34a defines the water level to be stored in tank 21. In this condition, bulkhead 25, i.e., the upper edge 26 thereof, protrudes above the water level. When heating element 22 is now activated causing the water to evaporate, the protruding portion of bulkhead 25 prevents water from splashing out. In order to additionally calm the bubbling water within the tank, baffle plates 32 are disposed within tank 21, said baffle plates extending from the top cover of tank 21 toward water surface 28 and terminating at a distance of from 1 to 30 mm above the water level 28 to be stored, or exactly at water surface 28. This ensures that only excessively bubbling water is calmed, while the flow of water remains unimpaired, or at least substantially unimpaired, as water is introduced into and through the tank, and further through conduit 16 (FIG. 1) and nozzle 17 (FIG. 1). In order to promote the flow of water through duct 34, duct 34 may be inclined at an angle of about 30 to 60 degrees with respect to the horizontal H. Horizontal H usually corresponds to the water surface 28 of the water 28a to be stored.

What is claimed is:

1. A steam generating-device configured to generate steam that is passed through a conduit and a nozzle into a container of a laundry appliance, the container configured to receive laundry to be treated, the steam-generating device comprising:
a tank including an interior space;
a heating element;
an inlet opening for admitting water into the tank;
an outlet opening for at least one of water and steam;
at least one bulkhead extending from a bottom of the tank between the outlet opening and the interior space, the bulkhead having an upper edge forming at least one opening so as to provide a passage for the steam between the interior space and the outlet opening,
wherein the upper edge protrudes above a storage water level of the tank.

2. The steam-generating device as recited in claim 1, wherein the bulkhead is movable between a first position on the bottom of the tank and a second position spaced at a distance from the bottom of the tank.

3. The steam-generating device as recited in claim 1, wherein the bulkhead is movable between a first position on the bottom of the tank and a second position in which a water passage is provided between the interior space of the tank and the outlet opening.

4. The steam-generating device as recited in claim 2 further comprising an electrically controllable actuator configured to drive movement of the bulkhead.

5. The steam-generating device as recited in claim 2 further comprising a pivot pin on which the bulkhead is pivotally mounted.

6. The steam generating device as recited in claim 1 further comprising at least one baffle plate disposed within the tank and extending from a top of the tank, the baffle plate being disposed between the bulkhead and an opposite end of the tank by a distance of between about one third and one half of a longitudinal length of the tank.

7. The steam generating device as recited in claim 6 wherein a lower edge of the baffle plate terminates at or above a surface of water in the tank.

8. The steam-generating device as recited in claim 1 wherein the at least one opening is included in a duct disposed between the interior space of the tank and the outlet opening, the duct forming a siphon.

9. The steam-generating device as recited in 8 wherein the duct extends over the upper edge of the bulkhead.

10. The steam-generating device as recited in claim 8 wherein the duct is inclined on a side facing the tank at an angle between about 30 and about 60 degrees with respect to a horizontal axis.

11. The steam-generating device as recited in claim 9 wherein the duct is inclined on a side facing the tank at an angle between about 30 and about 60 degrees with respect to a horizontal axis.

12. The steam-generating device as recited in claim 1 wherein the inlet opening is disposed in the tank at a side of the tank that is remote from the bulkhead and outlet opening.

13. The steam-generating device as recited in claim 1 wherein the heating element is disposed externally to an underside of the tank.

14. The steam-generating device as recited in claim 1 further comprising a mounting device attached to an outside of the tank.

15. The steam-generating device as recited in claim 1 further comprising a mounting device integrally formed with an outside of the tank.

16. A laundry appliance comprising a steam-generating device, a conduit, a nozzle and a container configured to receive laundry and disposed such that steam from the steam-generating device is passed through the conduit and nozzle to the container, the steam-generating device comprising:
a tank including an interior space;
a heating element;
an inlet opening for admitting water into the tank;
an outlet opening for at least one of water and steam;
at least one bulkhead extending from a bottom of the tank between the outlet opening and the interior space, the bulkhead having an upper edge forming at least one opening so as to provide a passage for the steam between the interior space and the outlet opening,
wherein the upper edge protrudes above a storage water level of the tank.

17. The laundry appliance as recited in claim 16, wherein the laundry appliance includes a washing machine.

18. The laundry appliance as recited in claim 16, wherein the laundry appliance includes a dryer.

19. The steam-generating device as recited in claim 1, wherein the bulkhead is movable between a first position on the bottom of the tank and a second position spaced by a distance from the bottom of the tank.

20. The steam-generating device as recited in claim 1 further comprising a duct disposed between the interior space of the tank and the outlet opening, the duct forming a siphon so as to provide an opening and a passage for steam.
